(19) United States
(12) Patent Application Publication
(10) Pub. No.: US 2026/0113810 A1
(43) Pub. Date: Apr. 23, 2026

(54) DEVICES, SYSTEMS, AND METHODS FOR EQUALIZING THE THERMAL DENSITY OF A HEATER CONSTRUCTED FROM A FLEXIBLE CIRCUIT

(71) Applicant: Liquid Wire Inc., Portland, OR (US)

(72) Inventors: Katherine M. Nelson, Portland, OR (US); Vaughn Earl Spielman, Portland, OR (US); Trevor Antonio Rivera, Portland, OR (US); Michael Jasper Wallans, Portland, OR (US)

(73) Assignee: Liquid Wire Inc., Portland, OR (US)

(21) Appl. No.: 19/278,465

(22) Filed: Jul. 23, 2025

Related U.S. Application Data
(63) Continuation of application No. PCT/US24/12663, filed on Jan. 23, 2024.
(60) Provisional application No. 63/481,175, filed on Jan. 23, 2023.
(60) Provisional application No. 63/500,201, filed on May 4, 2023.

(51) Int. Cl. H05B 1/02; H05B 3/00; H05B 3/54

(52) U.S. Cl. CPC H05B 1/0216; H05B 1/0252; H05B 3/0019; H05B 3/54; H05B 2203/003; H05B 2203/005; H05B 2203/035; H05B 2203/036; H05B 2203/037

(57) ABSTRACT

Various articles and methods for controlling an amount of thermal energy generated by the articles are disclosed herein. For example, an article can include a power source and a flexible circuit electrically coupled to the power source. The flexible circuit can include a trace including a deformable conductor. The trace can define a plurality of switchbacks. The plurality of switchbacks can be configured to generate a predetermined amount of thermal energy when a voltage from the power source is applied to the trace.

### CROSS-REFERENCE TO RELATED APPLICATIONS

The present application is a non-provisional application claiming the benefit under 35 U.S.C. § 119(e) of U.S. Provisional Ser. No. 63/481,175 , titled DEVICES, SYSTEMS, AND METHODS FOR EQUALIZING THE THERMAL DENSITY OF A HEATER CONSTRUCTED FROM A FLEXIBLE CIRCUIT, filed Jan. 23, 2023, and U.S. Provisional Ser. No. 63/500,201 , titled DEVICES, SYSTEMS, AND METHODS FOR EQUALIZING THE THERMAL DENSITY OF A HEATER CONSTRUCTED FROM A FLEXIBLE CIRCUIT, filed May 4, 2023, the disclosures of which are hereby incorporated by reference in their entirety.

All applications referenced herein are relevant to the subject matter disclosed herein and are hereby incorporated by reference in their entirety, regardless of the specific portion of the specification in which they are referenced.

### FIELD

The present disclosure is generally related to flexible circuits and, more particularly, is directed to flexible circuits that can be integrated into a heater and, more specifically, provide optimized trace configurations for heaters constructed from flexible circuits.

### SUMMARY

The following summary is provided to facilitate an understanding of some of the innovative features unique to the aspects disclosed herein and is not intended to be a full description. A full appreciation of the various aspects can be gained by taking the entire specification, claims, and abstract as a whole.

In various aspects, an article is disclosed. The article can include a power source and a flexible circuit electrically coupled to the power source. The flexible circuit can include a trace including a deformable conductor configured to generate a predetermined amount of thermal energy when a voltage from the power source is applied to the trace.

In various aspects, a system is disclosed. The system can include a power source and an article including a flexible circuit configured to be electrically coupled to the power source. The article includes a trace including a deformable conductor. The trace is configured to generate thermal energy when a voltage from the power source is applied to the trace. The system can further include a processor communicably coupled to the power source and the flexible circuit, and a memory configured to store instructions that, when executed by the processor, cause the processor to receive a signal from the flexible circuit corresponding to a characteristic of the flexible circuit, determine that the characteristic exceeds a predetermined threshold based on the received signal, and cause the power source to lower the voltage and/or a current applied to the trace based on the determination that the characteristic exceeds the predetermined threshold.

In various aspects, a method of controlling a generated amount of thermal energy by a flexible circuit of an article is disclosed. The flexible circuit can include a trace including a deformable conductor. The trace is configured to generate a first amount of thermal energy when a voltage is applied to the trace via a power source. The method can include causing, via a processor, a power source to apply the voltage to the flexible circuit, receiving, via the processor, a first signal from the flexible circuit corresponding to the first amount of thermal energy, determining, via the processor, that the first amount of thermal energy is below a predetermined threshold based on the first signal, generating a second amount of thermal energy when the voltage is applied to the trace in response to a motion of the article, receiving, via the processor, a second signal from the flexible circuit corresponding to the second amount of thermal energy, determining, via the processor, that the second amount of thermal energy exceeds the predetermined threshold based on the second signal, and causing, via the processor, the power source to lower the voltage and/or current applied to the trace based on the determination that the second amount of thermal energy exceeds the predetermined threshold.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a wearable article featuring a flexible circuit configured to function as a heater according to at least one non-limiting aspect of the present disclosure;

FIG. 2 illustrates a system for equalizing thermal energy generated by a flexible circuit of a wearable article, according to at least one non-limiting aspect of the present disclosure;

FIG. 3 illustrates a method for controlling thermal energy generated by a flexible circuit of a wearable article, according to at least one non-limiting aspect of the present disclosure; and

FIG. 4 illustrates another flexible circuit configured to function as a heater and configured for use with the wearable article of FIG. 1, according to at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves any and all copyrights disclosed herein.

Flexible and deformable electronic circuits have emerged as a means of innovating conventional electronics. It can be beneficial to implement flexible circuits as heating elements for applications. For example, a flexible circuit can provide an exceptional means of heating a wearable article (e.g., a jacket, a glove, a sock, etc.) because the flexible circuit can facilitate instead of inhibit motion. However, circuits made from conventional flexible conductors are generally limited by flexion and fatigue, a problem that is only exacerbated if those conductors are used to generate and convey thermal energy. Accordingly, there is a need for devices, systems, and methods for equalizing the thermal density of a heater constructed from a flexible circuit.

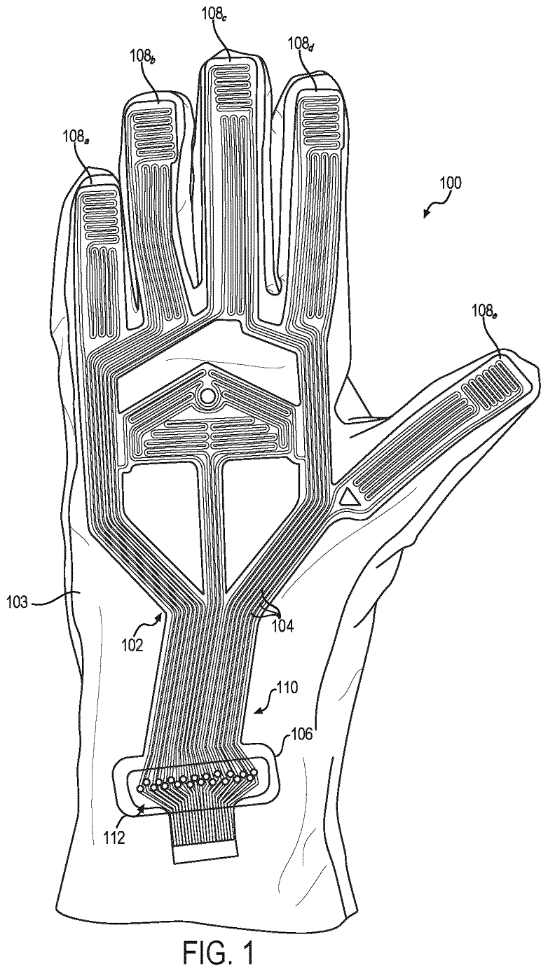

Referring now to FIG. 1, a wearable article 100 featuring a flexible circuit 102 configured to function as a heater according to at least one non-limiting aspect of the present disclosure. Although, according to the non-limiting aspect of FIG. 1, the wearable article 100 includes a glove, it shall be appreciated that the principles contemplated by the present disclosure and disclosed herein can be applied to achieve similar benefits for any number of wearable articles, including a shirt, pants, socks, underpants, shoes, a scarf, a brace, a sleeve, and/or a hat, amongst others. According to the non-limiting aspect of FIG. 1, the flexible circuit can include a laminate structure constructed from one or more unitized layers. For example, the traces 104 can be formed by depositing the deformable conductor onto a substrate layer and encapsulating it. For example, according to some non-limiting aspects, the flexible circuit 102 can be formed according to iterative stencil-in-place processes described in U.S. Patent Application Publication No. 2020/0066628, titled STRUCTURES WITH DEFORMABLE CONDUCTORS, filed Aug. 22, 2019, the disclosure of which is hereby incorporated by reference in its entirety. However, as noted above, the formation of the flexible circuit 102 as a laminate structure is merely an example of a flexible circuit 102 construction and not a limitation. Accordingly, it shall be appreciated that any suitable technique for making the flexible circuit 102 may be applied instead of or in addition to the process of making the flexible circuit 102 as a laminate structure. Once constructed, the flexible structure can be adhered, or otherwise coupled, to a medium 103 of the wearable article 100. However, according to other non-limiting aspects, it shall be appreciated that the medium 103 of the wearable article 100 can be used as a substrate 106 (FIG. 1) of the flexible circuit.

One or more layers of the flexible circuit 102 of FIG. 1, such as the substrate 106, can be processed according to any other mechanism that exists or may be developed, including but not limited to injection molding, 3D printing, thermoforming, laser etching, die-cutting, and the like. For example, according to some non-limiting aspects, it might be preferable to use a B-stage resin film, a C-stage resin film, an adhesive, a thermoset epoxy-based film, thermoplastic polyurethane (“TPU”), and/or silicone, among other suitable compounds or materials for a substrate and/or encapsulation layer of the flexible circuit 102. In an example, the flexible circuit 102 may include a layer that has a tensile elongation of 550%, tensile modulus of 5.0 megapascals, recovery rate of 95%, thickness of 100 micrometers, a peel strength at 90 degrees of at least 1.0 kilonewtons per meter, a dielectric constant of 2.3 at 10 gigahertz, a dielectric dissipation factor of 0.0030 at 10 gigahertz, a breakdown voltage of 7.0 kilovolts at a thickness of 80 micrometers, a heat resistance that produces no change in an environment of 260 degrees Celsius for 10 cycles in a nitrogen atmosphere, and a chemical resistance producing no change to any layer of the flexible circuit 102 after 24 hours immersion in any of NaOH, Na2CO3, or copper etchant. Details of one or more layers of the flexible circuit 102, for example, are disclosed in U.S. Patent Application Publication No. 2020/0381349, titled CONTINUOUS INTERCONNECTS BETWEEN HETEROGENEOUS MATERIALS, Ronay et al., the disclosure of which is hereby incorporated by reference in its entirety.

In further reference to the non-limiting aspect of FIG. 1, the flexible circuit 102 can include one or more traces 104 formed from a deformable conductor deposited on a substrate 106 or medium and can be constructed in accordance with the techniques disclosed in U.S. Patent Application Publication No. 2020/0066628, titled STRUCTURES WITH DEFORMABLE CONDUCTORS, filed Aug. 22, 2018, the disclosure of which is hereby incorporated by reference in its entirety. For example, the deformable conductor can include a conductive gel that is integrated into a multi-layered medium, such as a laminate structure, enclosed with at least one encapsulation layer that seals the trace 104 or other component of the laminate structure. According to some non-limiting aspects, the flexible circuit 102 can further include a stencil layer (e.g., for when a stencil-in-place manufacturing process is utilized, a conductive layer (e.g., a relatively high-powered bus), a sensor, a ground plane, shielding, an insulation layer (e.g., between a substrate layer), a stencil layer, and/or an encapsulation layer, that primarily insulates traces or conductive layers from one another). According to still other non-limiting aspects, the flexible circuit 102 can further include an electronic component not necessarily formed according to the processes disclosed herein (e.g., a surface mount capacitor, resistor, processor, etc.), vias for connectivity between layers, and/or contact pads, amongst other components and structures.

The collection of layers of the flexible circuit 102 may be referred to as a “stack”. A final or intermediate structure may include at least one or more stacks that has been unitized. Additionally or alternatively, the flexible circuit 102 could comprise one or more unitized stacks with at least one electronic component (e.g., a processor, a power source, a sensor, etc.). A flexible circuit 102 may comprise multiple laminate structures (e.g., in a modular construction). The assembly may utilize island architecture including a first laminate structure (the “island”), which may typically but not exclusively be itself a laminate structure populated with electric components, or a laminate structure that is, for example, a discrete sensor, with the first laminate structure adhered to a second laminate structure. The coupling of laminate structures can include coupling traces and/or vias configured like a traditional printed circuit board (“PCB”). In other words, the flexible circuit 102 can provide pathways for signals, currents or potentials to travel between the island(s) and other auxiliary structures (e.g., sensors).

Still referring to FIG. 1, it shall be appreciated that the deformable conductors shall be particularly configured to possess the desired mechanical and electrical characteristics suitable for use in accordance with the heaters contemplated by the present disclosure. For example, the electrically conductive compositions, such as conductive gels, comprised in the articles described herein can, for example, have a paste like or gel consistency that can be created by taking advantage of, among other things, the structure that gallium oxide can impart on the compositions when gallium oxide is mixed into a eutectic gallium alloy. When mixed into a eutectic gallium alloy, gallium oxide can form micro or nanostructures that are further described herein, which structures are capable of altering the bulk material properties of the eutectic gallium alloy.

As used herein, the term “eutectic” generally refers to a mixture of two or more phases of a composition that has the lowest melting point, and where the phases simultaneously crystallize from molten solution at this temperature. The ratio of phases to obtain a eutectic is identified by the eutectic point on a phase diagram. One of the features of eutectic alloys is their sharp melting point.

In some aspects, the properties of the deformable conductive material and/or the properties of the layers surrounding the patterns of the deformable conductive material may be adjusted and/or optimized to ensure that the patterns of deformable conductive material heal upon unitization of the surrounding layers. For example, the deformable conductive material may be optimized to have a viscosity such that the deformable conductive material is able to heal upon unitization of the layers but not such that the deformable conductive material overly deforms and does not achieve the intended pattern. As another example, adhesive characteristics and/or viscosity of the deformable conductive material may be optimized such that it remains on the substrate layer upon removal of a removable stencil used to form the deformable conductive material. In some aspects, a viscosity of the deformable conductive material may, when under high shear (e.g., in motion), be in a range of about 10 Pascal seconds (Pa*s) and 500 Pa*s, such as a range of 50 Pa*s and 300 Pa*s, and/or may be about 50 Pa*s, about 60 Pa*s, about 70 Pa*s, about 80 Pa*s, about 90 Pa*s, about 100 Pa*s, about 110 Pa*s, about 120 Pa*s, about 130 Pa*s, about 140 Pa*s, about 150 Pa*s, about 160 Pa*s, about 170 Pa*s, about 180 Pa*s, about 190 Pa*s, or about 200 Pa*s. In some aspects, a viscosity of the deformable conductive material may, when under low shear (e.g., at rest), be in a range of 1,000,000 Pa*s and 40,000,000 Pa*s and/or may be about 10,000,000 Pa*s, about 20,000,000 Pa*s, about 30,000,000 Pa*s, or about 40,000,000 Pa*s.

The electrically conductive compositions described herein (e.g., the deformable conductive materials described herein) can have any suitable conductivity, such as a conductivity of from about 2×10⁵ S/m to about 8×10⁵ S/m.

The electrically conductive compositions described herein can have any suitable melting point, such as a melting point of from about −20° C. to about 10° C., about −10° C. to about 5° C., about −5° C. to about 5° C. or about −5° C. to about 0° C.

The electrically conductive compositions can comprise a mixture of a eutectic gallium alloy and gallium oxide, wherein the mixture of eutectic gallium alloy and gallium oxide has a weight percentage (wt%) in a range of about 59.9% and about 99.9% eutectic gallium alloy, such as in a range of about 67% and about 90%, and a wt% in a range of about 0.1% and about 2.0% gallium oxide such as in a range of about 0.2 and about 1%. For example, the electrically conductive compositions can have about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or greater, such as about 99.9% eutectic gallium alloy, and about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, and about 2.0% gallium oxide.

The eutectic gallium alloy can include gallium-indium or gallium-indium-tin in any ratio of elements. For example, a eutectic gallium alloy includes gallium and indium. The electrically conductive compositions can have any suitable percentage of gallium by weight in the gallium-indium alloy that is in a range of about 40% and about 95%, such as about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95%.

The electrically conductive compositions can have a percentage of indium by weight in the gallium-indium alloy that is in a range of about 5% and about 60%, such as about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

The eutectic gallium alloy can include gallium and tin. For example, the electrically conductive compositions can have a percentage of tin by weight in the alloy that is in a range of about 0.001% and about 50%, such as about 0.001%, about 0.005%, about 0.01%, about 0.05%, about 0.1%, about 0.2%, about 0.3%, about 0.4%, about 0.5%, about 0.6%, about 0.7%, about 0.8%, about 0.9%, about 1%, about 1.5%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50%.

The electrically conductive compositions can comprise one or more micro-particles or sub-micron scale particles blended with the eutectic gallium alloy and gallium oxide. The particles can be suspended, either coated in eutectic gallium alloy or gallium and encapsulated in gallium oxide or not coated in the previous manner, within eutectic gallium alloy. The micro-or sub-micron scale particles can range in size from nanometer to micrometer and can be suspended in gallium, gallium-indium alloy, or gallium-indium-tin alloy. Particle to alloy ratio can vary and can change the flow properties of the electrically conductive compositions. The micro and nanostructures can be blended within the electrically conductive compositions through sonication or other suitable means. The electrically conductive compositions can include a colloidal suspension of micro and nanostructures within the eutectic gallium alloy/gallium oxide mixture.

The electrically conductive compositions can further include one or more micro particles or sub-micron scale particles dispersed within the compositions. This can be achieved in any suitable way, including by suspending particles, either coated in eutectic gallium alloy or gallium and encapsulated in gallium oxide or not coated in the previous manner, within the electrically conductive compositions or, specifically, within the eutectic gallium alloy fluid. These particles can range in size from nanometer to micrometer and can be suspended in gallium, gallium-indium alloy, or gallium-indium-tin alloy. Particle to alloy ratio can vary, in order to, among other things, change fluid properties of at least one of the alloys and the electrically conductive compositions. In addition, the addition of any ancillary material to colloidal suspension or eutectic gallium alloy in order to, among other things, enhance or modify its physical, electrical or thermal properties. The distribution of micro and nanostructures within the at least one of the eutectic gallium alloy and the electrically conductive compositions can be achieved through any suitable means, including sonication or other mechanical means without the addition of particles. In certain embodiments, the one or more micro-particles or sub-micron particles are blended with the at least one of the eutectic gallium alloy and the electrically conductive compositions with wt% in a range of about 0.001% and about 40.0% of micro-particles, for example about 0.001%, about 0.005%, about 0.01%, about 0.05%, about 0.1%, about 0.2%, about 0.3%, about 0.4%, about 0.5%, about 0.6%, about 0.7%, about 0.8%, about 0.9%, about 1%, about 1.5%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40.

The one or more micro-or sub-micron particles can be made of any suitable material including soda glass, silica, borosilicate glass, quartz, oxidized copper, silver coated copper, non-oxidized copper, tungsten, super saturated tin granules, glass, graphite, silver coated copper, such as silver coated copper spheres, and silver coated copper flakes, copper flakes, or copper spheres, or a combination thereof, or any other material that can be wetted by the at least one of the eutectic gallium alloy and the electrically conductive compositions. The one or more micro-particles or sub-micron scale particles can have any suitable shape, including the shape of spheroids, rods, tubes, a flakes, plates, cubes, prismatic, pyramidal, cages, and dendrimers. The one or more micro-particles or sub-micron scale particles can have any suitable size, including a size range of about 0.5 microns to about 60 microns, as about 0.5 microns, about 0.6 microns, about 0.7 microns, about 0.8 microns, about 0.9 microns, about 1 microns, about 1.5 microns, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, about 30 microns, about 31 microns, about 32 microns, about 33 microns, about 34 microns, about 35 microns, about 36 microns, about 37 microns, about 38 microns, about 39 microns, about 40 microns, about 41 microns, about 42 microns, about 43 microns, about 44 microns, about 45 microns, about 46 microns, about 47 microns, about 48 microns, about 49 microns, about 50 microns, about 51 microns, about 52 microns, about 53 microns, about 54 microns, about 55 microns, about 56 microns, about 57 microns, about 58 microns, about 59 microns, or about 60 microns.

The electrically conductive compositions described herein can be made by any suitable method, including a method comprising blending surface oxides formed on a surface of a eutectic gallium alloy into the bulk of the eutectic gallium alloy by shear mixing of the surface oxide/alloy interface. Shear mixing of such compositions can induce a cross linked microstructure in the surface oxides; thereby forming a conducting shear thinning gel composition. A colloidal suspension of micro-structures can be formed within the eutectic gallium alloy/gallium oxide mixture, for example as, gallium oxide particles and/or sheets.

The surface oxides can be blended in any suitable ratio, such as at a ratio in a range of about 59.9% (by weight) and about 99.9% eutectic gallium alloy, to about 0.1% (by weight) and about 2.0% gallium oxide. For example percentage by weight of gallium alloy blended with gallium oxide is about 60%, 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or greater, such as about 99.9% eutectic gallium alloy while the weight percentage of gallium oxide is about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, and about 2.0% gallium oxide. In embodiments, the eutectic gallium alloy can include gallium-indium or gallium indium-tin in any ratio of the recited elements. For example, a eutectic gallium alloy can include gallium and indium.

The weight percentage of gallium in the gallium-indium alloy can be in a range of about 40% and about 95%, such as about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95%.

Alternatively or in addition, the weight percentage of indium in the gallium-indium alloy can be in a range of about 5% and about 60%, such as about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

A eutectic gallium alloy can include gallium, indium, and tin. The weight percentage of tin in the gallium-indium-tin alloy can be in a range of about 0.001% and about 50%, such as about 0.001%, about 0.005%, about 0.01%, about 0.05%, about 0.1%, about 0.2%, about 0.3%, about 0.4%, about 0.5%, about 0.6%, about 0.7%, about 0.8%, about 0.9%, about 1%, about 1.4%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50%.

The weight percentage of gallium in the gallium-indium-tin alloy can be in a range of about 40% and about 95%, such as about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95%.

Alternatively or in addition, the weight percentage of indium in the gallium-indium-tin alloy can be in a range of about 5% and about 60%, such as about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

One or more micro-particles or sub-micron scale particles can be blended with the eutectic gallium alloy and gallium oxide. For example, the one or more micro-particles or sub-micron particles can be blended with the mixture with wt% in a range of about 0.001% and about 40.0% of micro-particles in the composition, for example about 0.001%, about 0.005%, about 0.01%, about 0.05%, about 0.1%, about 0.2%, about 0.3%, about 0.4%, about 0.5%, about 0.6%, about 0.7%, about 0.8%, about 0.9%, about 1%, about 1.5%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40. In embodiments the particles can be soda glass, silica, borosilicate glass, quartz, oxidized copper, silver coated copper, non-oxidized copper, tungsten, super saturated tin granules, glass, graphite, silver coated copper, such as silver coated copper spheres, and silver coated copper flakes, copper flakes or copper spheres or a combination thereof, or any other material that can be wetted by gallium. In some embodiments the one or more micro-particles or sub-micron scale particles are in the shape of spheroids, rods, tubes, a flakes, plates, cubes, prismatic, pyramidal, cages, and dendrimers. In certain embodiments, the one or more micro-particles or sub-micron scale particles are in the size range of about 0.5 microns to about 60 microns, as about 0.5 microns, about 0.6 microns, about 0.7 microns, about 0.8 microns, about 0.9 microns, about 1 microns, about 1.5 microns, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, about 30 microns, about 31 microns, about 32 microns, about 33 microns, about 34 microns, about 35 microns, about 36 microns, about 37 microns, about 38 microns, about 39 microns, about 40 microns, about 41 microns, about 42 microns, about 43 microns, about 44 microns, about 45 microns, about 46 microns, about 47 microns, about 48 microns, about 49 microns, about 50 microns, about 51 microns, about 52 microns, about 53 microns, about 54 microns, about 55 microns, about 56 microns, about 57 microns, about 58 microns, about 59 microns, or about 60 microns.

It shall be understood that unlike the deformable conductors of the traces 104 of the flexible circuit 102 of FIG. 1, most conventional elastic materials—especially those traditionally implemented in wearable articles—exhibit a low thermal conductivity. Conversely, a more rigid conductor may possess a more optimal thermal conductivity but would inherently inhibit the flexibility of the flexible circuit 102 and thus, the flexibility of the wearable article 100, itself. In other words, conventional conductors force the user to trade desirable mechanical properties for desirable thermal properties, and vice versa. However, the aforementioned characteristics distinguish the deformable conductors contemplated by the present disclosure from conventional elastic materials in that they act as a thermally conductive rubbery material configured to provide a relatively-efficient conveyance of thermal energy, which renders them improved for implementation via a flexible circuit 102 configured to function as a heater in a wearable article 100.

Additionally, the one or more traces 104 of the flexible circuit 102 of FIG. 1 are constructed from deformable conductors and substrate materials combining to have advantageous hysteresis characteristics. For example, alternate conductors (e.g., silver ink, etc.) may experience high hysteresis if implemented in the flexible circuit 102 and thus, would experience measurable changes in thermo-electrical characteristics upon returning to a relaxed state after undergoing a number of deformation cycles. This is generally known as “strain creep,” which results in a degradation in circuit performance as the number of deformation cycles increases. According to such aspects, the performance of the flexible circuit 102 that utilizes the aforementioned deformable conductors and substrate materials is enhanced. Moreover, the viscosity characteristics of the one or more traces 104 can even cause the deformable conductor to “heal” an open in the traces of the flexible circuit 102 if one should occur, e.g., intentionally during the patterning of the traces during manufacturing, or unintentionally during operation of the circuit 102.

In further reference to the non-limiting aspect of FIG. 1, the flexible circuit 102 can be further configured to produce a desired heat output for a particular application. For example, the flexible circuit 102 of FIG. 1 can include a plurality of traces 104 (e.g., ten circuitous traces 104), each of which terminate in an interconnect board 112 mounted to the substrate 106. It shall be appreciated that each trace 104 can be configured as an individual “heater run” and that, generally speaking, heat is generated along the entire length of each trace 104 when a voltage is applied to the flexible circuit 102. The traces 104, therefore, can be geometrically configured to generate a desired amount of heat in a desired portion of the wearable article 102, thereby equalizing or individualizing the amount of thermal energy generated by different portions of the flexible circuit 102.

According to the non-limiting aspect of FIG. 1, at least a subset of the plurality of traces 104 is configured to form a plurality of first portions 108ₐ₋ₑ of the flexible circuit 102 and a second portion 110 of the flexible circuit 102. The first portions 108ₐ₋ₑ and second portion 110 are particularly arranged such that the flexible circuit 102 generates a desired amount of thermal energy across those portions 108ₐ₋ₑ, 110, respectively. As will be understood, Joule heating can generate power through the one or more of the traces 104 of the flexible circuit 102 of FIG. 1 based on the applied current (I) and the resistance (R) of the deformable conductor, in accordance with the following equation: P=I²R. The resistance and therefore power depends on the width and length of the trace 104. For example, as the length of any particular trace 104 increases, so will the resistance and thus, as will the power generated as thermal energy.

For example, each of the first portions 108ₐ₋ₑ of the flexible circuit 102 of FIG. 1 can include a single trace 104 that is arranged in a series of switchbacks along the finger and fingertip portion of the wearable article 100. In other words, the trace 104 across each finger in the first portions 108ₐ₋ₑ is longer and thus, the resistance generated across each of the first portions 108ₐ₋ₑ will increase, as will the power and thermal energy generated. The switchbacks can be positioned along each finger and fingertip of the wearable article 100, for example, because a user's extremities (e.g., fingers) may get colder before the rest of the user's body or body parts (e.g., palms of the hands). However, it shall be similarly appreciated that the power consumed for a given applied current will also increase in proportion to the quantity of traces 104 in any given portion of the wearable article 100. For example, at the second portion 110 of the flexible circuit 102, each trace 104 of the plurality is converging back to the interconnect board 112 and thus, the thermal energy generated across the second portion 110 will increase, thereby keeping the user's wrist warm as well. In other words, the one or more traces 104 of the flexible circuit 102 of FIG. 1 can be particularly configured such that a density of the thermal energy generated by the one or more traces 104 is equalized across the flexible circuit 102, or individualized as desired for the intended use and/or application or user preferences.

In further reference to the non-limiting aspect of FIG. 1, it shall be understood that thermal energy is, for example, heat energy generated via resistance when a current and/or voltage is applied to the one or more traces 104 of the flexible circuit 102 of FIG. 1. In one aspect, amount of thermal energy (P) generated by the one or more traces 104 may be determined, or predetermined, based on the resistance (R) of and the current (I) applied to the one or more traces 104, in accordance with the following equation: P=I²R. In another aspect, an amount of thermal energy (P) generated by the one or more traces 104 may be determined, or predetermined, based on the resistance (R) of and the voltage (V) applied to the one or more traces 104, in accordance with the following equation: P=V²/R.

An amount of thermal energy generated by the one or more traces 104 of the flexible circuit 102 of FIG. 1 can be measured or otherwise determined based on a signal generated by and/or a characteristic value of the flexible circuit 102. For example, the flexible circuit 102 generate a signal corresponding to a measured or otherwise determined current (I), voltage (V), and/or resistance (R) of the one or more traces 104. A characteristic value of the flexible circuit 102 can include the measured or otherwise determined current (I), voltage (V), and/or resistance (R) of the one or more traces 104. An amount of thermal energy generated by the one or more traces 104 can be derived (e.g., by a processor executing stored instructions) based on the current (I), voltage (V), and/or resistance (R) of the one or more traces 104, for example, according to the relationship between thermal energy (P), current (I), and resistance (R) (e.g., P=I²R) and/or the relationship between thermal energy (P), voltage (V), and resistance (R) (e.g., P=V²/R) described above.

It shall be appreciated that the depicted configurations are merely illustrative and that similar principles can be applied to a variety of different portions of different flexible circuits coupled to many different wearable articles to achieve a similar effect and benefit. Accordingly, the aspect of FIG. 1 is illustrative and not limiting.

Still referring to FIG. 1, the traces 104 of the flexible circuit 102 can be further configured to achieve an optimized ratio between current and a cross-sectional area of the trace 104 to generate a desired heat output for a given amount of strain anticipated to be introduced to the flexible circuit 102 as the user moves in the wearable article 100. Absent such optimization, the flexible circuit 102 could fail due to asperity. In other words, since the wearable article 100 will flex and stretch when in use, the flexible circuit 102 will undergo strain that will reduce the cross-sectional area of each trace 104. Thus, according to the non-limiting aspect of FIG. 1, the width and/or height of each trace 104 can be optimized for a certain range of motion.

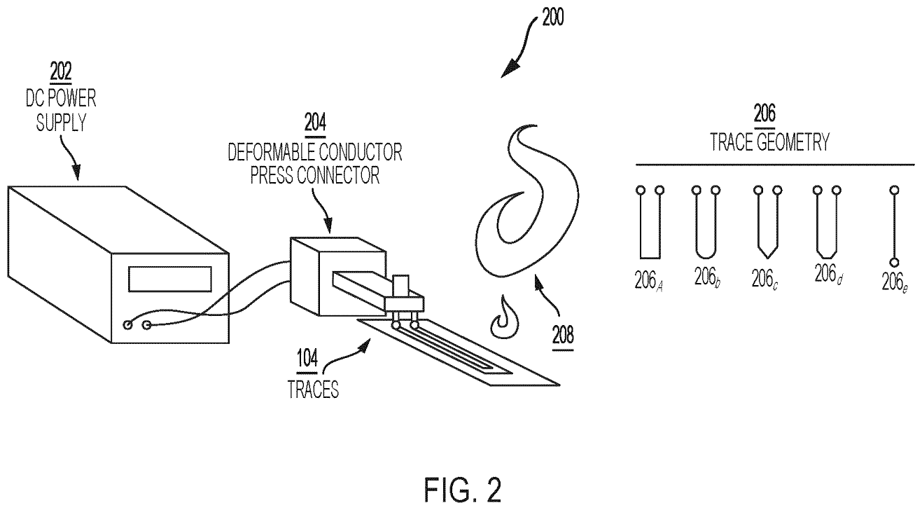

For example, experimentation using the system 200 of FIG. 2 indicates that the power and amperage, in some aspects, should be considered when optimizing the width and/or height of each trace 104. For example, experiments have indicated that the trace 104 configuration of the flexible circuit 102 of FIG. 1 is optimized for a power in a range of 2.0 and 2.4 W, and preferably approximately 2.2W, as well as an amperage in a range of 0 and 2 A, and preferably approximately 1 A. Likewise, similar experiments indicate that, in some aspects, when the trace has a small radius turn defining an angle (e.g., angle of a turn before a substantially straight run of deformable conductor), such turns should be generally limited to a maximum range of from 75 to 110 degrees, and preferably no more than 90 degrees. For example, this is why each switchback of the first portion 108ₐ₋ₑ of traces 104 of the flexible circuit 102 of FIG. 1 has a somewhat boxy configuration, comprising a 90 first degree trace angle, then a straight section, and subsequently a second 90 degree angle. It shall also be appreciated that a length of each straight section of the trace 104 can be greater than or equal to the width of each trace 104.

As previously discussed, the present disclosure shall not be limited to the specific trace 104 configuration of FIG. 1. For example, according to other non-limiting aspects, a radial trace 104 configuration can be used accomplish a change in trace 104 path and/or direction, where the radius of the change in path and/or direction is at least 1.5 times the trace 104 width.

It shall be further appreciated that, according to other non-limiting aspects, the flexible circuit 102 can be configured as a strain sensor, as disclosed in International Patent Application No. PCT/US2022/078522, titled TWO DIMENSIONAL MOTION CAPTURE STRAIN GAUGE SENSOR, filed Oct. 10, 2021, the disclosure of which is hereby incorporated by reference in its entirety. Thus, when a voltage is applied to the traces 104, each trace 104 could simultaneously provide strain data for a targeted region of the body for which part the flexible circuit 102 is worn on, so long as the flexible circuit 102 is communicably coupled to an electronic component configured to measure resistance. For example, according to some non-limiting aspects, the flexible circuit 102 can include an on-board processor configured to process signals received off each trace 104. Alternately, the flexible circuit 102 can include a transmitter configured to transmit signals generated by each trace 104 of the flexible circuit 102 to a processor for remote processing. Accordingly, the trace 104 designs of FIG. 1 can be optimized to generate the desired heat output and also to provide relatable information associated with each finger's motion, as described in U.S. Provisional Ser. No. 63/268,063 , titled DEVICES, SYSTEMS, AND METHODS FOR GENERATING AND CORRELATING ELECTRICAL PARAMETERS TO THE PHYSICAL MOTIONS OF A USER, filed Feb. 15, 2022, the disclosure of which is hereby incorporated by reference in its entirety. According to some non-limiting aspects, certain portions of the flexible circuit 102 can be “locked out” (e.g., wrist, bones between knuckles, etc.) such that the active portions 108ₐ₋ₑ of the trace 104 are only one or more joints of the finger.

Moreover, it shall be appreciated that the wearable article 100 is intended to be worn and that as the user moves, the traces 104 will deform, increasing an amount of strain applied to each trace 104, particularly when a voltage is applied to the flexible circuit 102 and current is flowing through the traces 104. As such, according to other non-limiting aspects, the flexible circuit 102 can be configured for selective control of the current across each trace 104 to compensate for different overall trace 104 elongations or other physical changes to the trace 104, e.g., reduced cross sectional area, etc. In one example, this can further ensure that if the density of heat being generated is desired to be equalized throughout the wearable article 100, and if it is not possible to create substantially equal trace 104 lengths (or equal resistance in each trace) for a given geometry and/or desired portion 108ₐ₋ₑ, 110 of the flexible circuit 102. In another example, current can be increased to one or more regions of the circuit 102 where more heat is desired, e.g., in trace(s) that traverse the region(s) where more heat is desired, and/or the current supplied to one or more regions of the circuit 102 where less heat is desired, e.g., in trace(s) that traverse the region(s) where less heat is desired. In yet another example, according to some non-limiting aspects, the flexible circuit 102 can be communicably coupled to an electronic component (e.g., an ohmmeter, a processor, a controller, etc.) and the current can be adjusted if threshold strain values are detected. In other words, a processor can be implemented to assess changes in circuit 102 characteristic values, e.g., resistance or thermal energy output, over time to monitor the “acceleration” and/or speed of change of those circuit 102 characteristic values, and to project and/or anticipate whether circuit 102 characteristic values, e.g., trace resistance or amount of thermal energy output by a trace, will exceed a threshold value which may cause an over-power condition that may damage the traces 104. According to still other non-limiting aspects, the processor can be configured to throttle back, or reduce, the current in anticipation of threshold circuit 102 characteristic values being reached during a specific activity or motion, before the threshold is exceeded. This can prevent the risk of trace 104 failures due to asperity as the traces 104 deform when the wearable article 100 is used. Once threshold circuit 102 characteristic values are reduced, or those certain activities or motions recognized as risking trace failure cease, the controller may cause current to resume at desired levels to produce the amount of heat desired from circuit 102.

According to still other non-limiting aspects, the flexible circuit 102 of FIG. 1 can be configured to heating as well as a sensing application. For example, a pressure-sensing application can be implemented via a stacked strain sensing configuration of the flexible circuit 102, as disclosed in International Patent Application Publication No. WO2020/247697A1, titled DEFORMABLE SENSORS WITH SELECTIVE RESTRAINT, filed Jun. 4, 2020, the disclosure of which is hereby incorporated by reference in its entirety. Alternately and/or additionally, the traces 104 of the flexible circuit 102 can be configured in a manner that enables a capacitive touch sensing application as disclosed in International Patent Application No. PCT/US2023/071790, titled DEVICES, SYSTEMS, AND METHODS FOR PRESSURE MAPPING A FOOT OF A USER, filed Aug. 7, 2023, the disclosure of which is hereby incorporated by reference in its entirety.

According to still other non-limiting aspects, the wearable article 100 of FIG. 1 can include a thermally reflective material (e.g., Mylar) or a thermal insulator over an outermost surface of the medium 103 (e.g., opposite the wearer's skin). Thus, the wearable article 100 can contain heat and ensure an equal distribution of heat within a cavity defined by the wearable article 100. For example, according to the non-limiting aspect of FIG. 1, the wearable article 100 can be heated to about 60 degrees Celsius with a total consumption of 9.6 W, with a maximum amperage of about 1 A. According to the non-limiting aspect of FIG. 1, where the flexible circuit 102 includes approximately ten circuitous traces 104, it is estimated that the flexible circuit 102 can run at approximately 1 V/1 A or 2 V/0.5 A.

As previously discussed, it shall be further appreciated that in areas where greater flex is expected (e.g., the fingers), there will be an increase in localized resistance. Therefore, it may be beneficial to have increased deformable conductor volumes in localized areas. For example, according to some non-limiting aspects, at least a portion of each first portion 108ₐ₋ₑ of the traces 104 can include an increase in trace width and/or height compared to other portions of the traces 104. As such, when each first portion 108ₐ₋ₑ of the traces 104 undergoes an increased strain due to articulation of the joint, the traces can be designed such that the temperature will not be increased beyond a predetermined threshold value in those localized areas, thereby further mitigating the risk of failure due to asperity.

Accordingly, the devices, systems, and methods disclosed herein can improve durability by reducing fatigue of the traces 104, for example, compared to the fatigue experienced by conventional, solid-wire type conductors that may be otherwise used as a resistive heating element. The deformations, stretch, and flexion provided by the deformable conductors of the traces 104 disclosed herein are also not possible with solid-wire type heating elements, which would render a wearable article 100 less comfortable and bulkier. For example, if made with conventional heating elements, the wearable article 100 would likely need to be baggier such that joints could articulate without exceeding an allowable bend radius and/or number of cycles to reach a target life cycle of the wearable article 100. Accordingly, the wearable article 100 and flexible circuit 102 of FIG. 1 can provide a significant improvement in comfort and form factor over conventional devices.

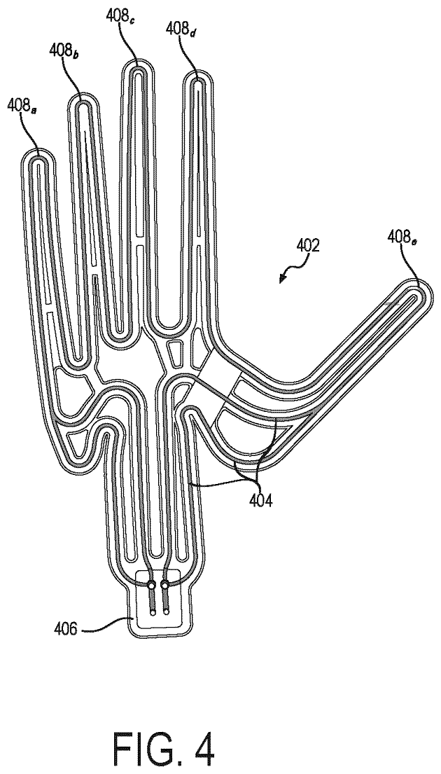

Referring now to FIG. 4, another flexible circuit 402 configured to function as a heater and configured for use with the wearable article 100 of FIG. 1 is depicted in accordance with at least one non-limiting aspect of the present disclosure. Once again, the flexible circuit 402 can include a laminate structure constructed from one or more unitized layers and the traces 404 can be formed by depositing the deformable conductor onto a substrate 406 and encapsulating it. For example, according to some non-limiting aspects, the flexible circuit 402 can be formed according to iterative stencil-in-place processes described in U.S. Patent Application Publication No. 2020/0066628, titled STRUCTURES WITH DEFORMABLE CONDUCTORS, filed Aug. 22, 2019, the disclosure of which is hereby incorporated by reference in its entirety. However, as noted above, the formation of the flexible circuit 402 as a laminate structure is merely an example of a flexible circuit 402 construction and not a limitation. Accordingly, it shall be appreciated that any suitable technique for making the flexible circuit 402 may be applied instead of or in addition to the process of making the flexible circuit 402 as a laminate structure. Once constructed, the flexible structure can be adhered, or otherwise coupled, to the wearable article 100 (FIG. 1). However, according to other non-limiting aspects, it shall be appreciated that the medium 103 (FIG. 1) of the wearable article 100 (FIG. 1) can be used as the substrate 406 of the flexible circuit.

According to the non-limiting aspect of FIG. 4, the flexible circuit 402 can include a simplified trace 404 configuration relative to the trace 104 configuration of the flexible circuit 101 of FIG. 1. For example, the flexible circuit 402 of FIG. 4 can omit the switchback portions 108_{a-d} of the flexible circuit 102 of FIG. 1, and instead the traces 404 can form a configuration of loops 408_{a-d} that will generate an increased concentration of thermal energy when an electric current traverses through the flexible circuit 402. In spite of the simplified nature of the trace 404 configuration, it shall be appreciated that the flexible circuit 402 of FIG. 4 can operate to specifications substantially similar those previously described in reference to the flexible circuit 101 of FIG. 1, albeit with a modified electrical input. For example, it shall be appreciated that the amount of thermal energy generated by the flexible circuit 402 is proportional to the voltage or current applied to the flexible circuit 402. Therefore, if a user were to apply an electrical input to the flexible circuit 402 with an increased voltage relative to an electrical input provided to the flexible circuit 101 of FIG. 1, the flexible circuit 402 of FIG. 4 can generate a substantially similar output to the flexible circuit 101 of FIG. 1. However, it shall be appreciated that the trace 404 configuration of the flexible circuit 402 of FIG. 4 can be more economical, because without the switchback portions 108_{a-d} it can be easier to manufacture and may require less of the deformable conductor compared to the flexible circuit 102 of FIG. 1. According to some non-limiting aspects, electrical input can be further modified such that the concentration of thermal energy generated by the loops 408_{a-d} may be less than the thermal energy generated by the switchback portions 108_{a-d} of the flexible circuit 102 of FIG. 1. Thus, the flexible circuit 402 of FIG. 4 can be implemented for less extreme environments, or applications that are better suited for a more economic and/or efficient generation of thermal energy. When combined with insulating materials and/or materials that trap thermal energy, the circuit 402 may provide sufficient heat for a wide range of operating environments including those that may be considered extreme.

Referring now to FIG. 2, a system 200 for equalizing thermal energy generated by a flexible circuit of a wearable article is depicted in accordance with at least one non-limiting aspect of the present disclosure. For example, the system 200 of FIG. 2 can include a direct current power supply 202 and a deformable conductor press connector 204 configured to deform and thus, apply a strain to traces 104 of a flexible circuit. As previously discussed, Joule heating can generate power through the one or more of the traces 104 of the flexible circuit when the power supply 202 forces current (I) through the traces 104 as a function of the resistance (R) of the deformable conductor. Once again, the resistance depends on the width and length of the trace 104 so, as the length of any particular trace 104 increases due to the press connector 204, the resistance and thus, as the power generated as thermal energy 208 will also increase. According to some non-limiting aspects, a function generator and an oscilloscope can be used in the system 200 to determine the operating limits of an alternating current waveform through the traces 104.

The system 200 of FIG. 2 was used to assess the limits of an example deformable conductor when arranged in an example trace 104 configuration to assess safe operating current and power requirements for an example flexible circuit similar to that of the flexible circuit 102 of FIG. 1. The deformable conductor was determined to withstand at a minimum of 1 A, depending on the angle of turns in the trace 104. Alternately, the deformable conductor was configured to transmit at least 2.2 W of power depending on the geometry of the traces 206, as exhibited in 206a-e. Surprisingly, the width of the traces appeared to have little or no effect on the ampacity and power handling of the metal gel, although it was shown that using low-angle geometry in the traces 104 severely affected the ability of the current to flow through the traces 104. Pre-stretched traces 104 regularly proved capable of transmitting more current before failure. Accordingly, in some aspects, the traces 104 of the flexible circuit 102 of FIG. 1 may be pre-stretched prior to incorporation into the wearable article 100.

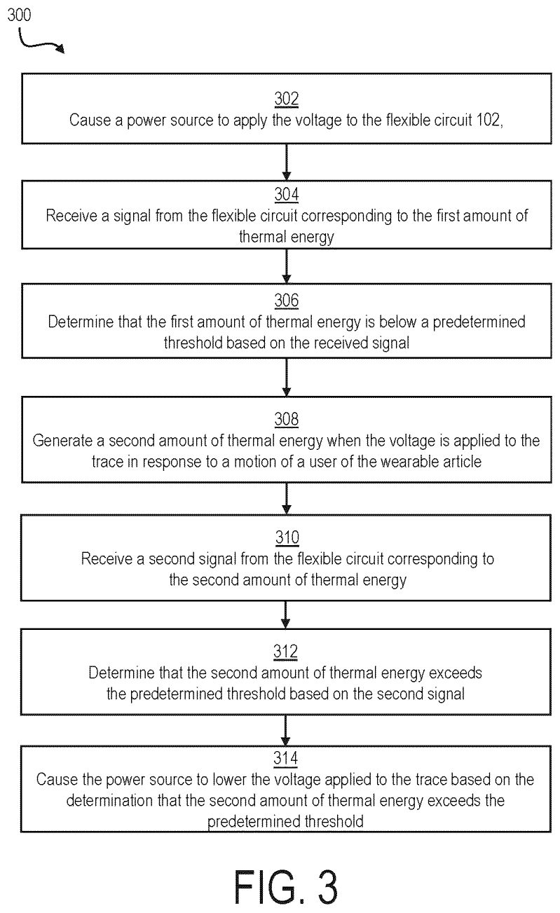

Referring now to FIG. 3, a method 300 for equalizing thermal energy generated by a flexible circuit of a wearable article is depicted in accordance with at least one non-limiting aspect of the present disclosure. For example, the method 300 can be implemented via a processor communicably coupled to the flexible circuit 102 of the wearable article 100 of FIG. 1, which the flexible circuit comprises a trace 104 made from a deformable conductor that defines a portion 108ₐ₋ₑ of switchbacks configured to generate a first amount of thermal energy when a voltage is applied to the trace via a power source. The method 300 can include causing 302 a power source to apply the voltage to the flexible circuit 102, receiving 304 a first signal from the flexible circuit 102 corresponding to the first amount of thermal energy, and determining 306 that the first amount of thermal energy is below a predetermined threshold based on receiving 304 the first signal. The method 300 can further include generating 308, via the plurality of switchbacks, a second amount of thermal energy when the voltage is applied to the trace in response to a motion of a user of the wearable article, receiving 310 a second signal from the flexible circuit 102 corresponding to the second amount of thermal energy, determining 312 that the second amount of thermal energy exceeds the predetermined threshold based on receiving the second signal, and causing 314 the power source to lower the voltage and/or current applied to the trace based on the determination that the second amount of thermal energy exceeds the predetermined threshold. However, the steps illustrated in FIG. 3 are not the exclusive steps of the method 300 contemplated by the present disclosure.

The circuits disclosed have been discussed for use in wearable applications and articles, however it shall be appreciated that these can include articles that are not worn by humans. For example, it shall be appreciated that an article can be for an animal, such as a horse, a dog, a cat, and the like. Furthermore, the article could be “worn” by a device or machine that operates in cold conditions, e.g., a robotic arm operating in a cold environment, whereby it is desired to maintain components above a certain operating temperature. Similarly, an article comprising a flexible and/or stretchable circuit according to the principles taught herein may be applied to infrastructure, e.g., pipes carrying fluids, which may require heat input to maintain the fluid above a threshold temperature, e.g., the freezing point of the fluid. Additionally, a radiant blanket may be made from one or more circuits configured according to the present disclosure and applied in a variety of use cases.

Since the inventive principles of this patent disclosure can be modified in arrangement and detail without departing from the inventive concepts, such changes and modifications are considered to fall within the scope of the following claims. The use of terms such as first and second are for purposes of differentiating different components and do not necessarily imply the presence of more than one component.

Various aspects of the subject matter described herein are set out in the following numbered clauses:

Clause 1: An article, including a power source and a flexible circuit electrically coupled to the power source, wherein the flexible circuit includes a trace including a deformable conductor configured to generate a predetermined amount of thermal energy when a voltage from the power source is applied to the trace.

Clause 2: The article according to Clause 1, wherein the trace is a first trace, wherein the predetermined amount of thermal energy is a first predetermined amount of thermal energy, and wherein the flexible circuit further includes at least one second trace including the deformable conductor, wherein at least a portion of the at least one second trace defines a region of the flexible circuit, and wherein the region is configured to generate a second predetermined amount of thermal energy when the voltage from the power source is applied to the at least one second trace.

Clause 3: The article according to either of Clauses 1 or 2, further including a processor communicably coupled to the power source and the flexible circuit, and a memory configured to store instructions that, when executed by the processor, cause the processor to receive a signal from the flexible circuit corresponding to a characteristic of the flexible circuit, determine that the characteristic of the flexible circuit is below a predetermined threshold based on the received signal, and cause the power source to increase the voltage and/or a current applied to the trace based on the determination that the characteristic is below the predetermined threshold.

Clause 4: The article according to any of Clauses 1-3, further including a processor communicably coupled to the power source and the flexible circuit, and a memory configured to store instructions that, when executed by the processor, cause the processor to receive a signal from the flexible circuit corresponding to a characteristic of the flexible circuit, determine that the characteristic of the flexible circuit exceeds a predetermined threshold based on the received signal, and cause the power source to lower the voltage and/or a current applied to the trace based on the determination that the characteristic exceeds the predetermined threshold.

Clause 5: The article according to any of Clauses 1-4, wherein the flexible circuit is configured as a strain sensor, and wherein the signal from the flexible circuit includes strain data corresponding to a physical change in the trace.

Clause 6: The article according to any of Clauses 1-5, wherein the flexible circuit is configured for selective control of current flowing through the first trace and the at least one second trace.

Clause 7: The article according to any of Clauses 1-6, wherein the trace includes switchbacks, wherein the article has at least one extremity, and wherein the switchbacks are located at the at least one extremity.

Clause 8: The article according to any of Clauses 1-7, wherein the voltage and/or the current applied to the trace is based on a motion of the article, and wherein the motion is inferred by the processor and the memory from the received signal.

Clause 9: A system, including a power source, an article including a flexible circuit configured to be electrically coupled to the power source, wherein the flexible circuit includes a trace including a deformable conductor, and wherein the trace is configured to generate thermal energy when a voltage from the power source is applied to the trace, a processor communicably coupled to the power source and the flexible circuit, and a memory configured to store instructions that, when executed by the processor, cause the processor to receive a signal from the flexible circuit corresponding to a characteristic of the flexible circuit, determine that the characteristic exceeds a predetermined threshold based on the received signal, and cause the power source to lower the voltage and/or a current applied to the trace based on the determination that the characteristic exceeds the predetermined threshold.

Clause 10: The system according to Clause 9, wherein the trace is a first trace, wherein the characteristic is a first amount of thermal energy generated by the first trace, and wherein the flexible circuit further includes at least one second trace including the deformable conductor, wherein at least a portion of the at least one second trace defines a region of the flexible circuit, and wherein the region is configured to generate a second amount of thermal energy when the voltage from the power source is applied to the at least one second trace.

Clause 11: The system according to either of Clauses 9 or 10, wherein the article is configured to lower the voltage and/or the current applied to the trace based on a motion of the article.

Clause 12: The system according to any of Clauses 9-11, wherein the signal is a first signal, the characteristic includes the second amount of thermal energy, and when executed by the processor the instructions further cause the processor to receive a second signal from the flexible circuit, determine that the second amount of thermal energy exceeds a predetermined threshold based on the second signal, and cause the power source to lower the voltage and/or the current applied to the at least one second trace based on the determination that the second amount of thermal energy exceeds the predetermined threshold.

Clause 13: The system according to any of Clauses 9-12, wherein the flexible circuit is configured as a strain sensor, and wherein the signal includes strain data corresponding a physical change in the trace.

Clause 14: The system according to any of Clauses 9-13, wherein the flexible circuit is configured for selective control of current flowing through the trace.

Clause 15: The system according to any of Clauses 9-14, wherein the at least one second trace is configured to have a plurality of switchbacks, wherein the article has at least one extremity, and wherein the plurality of switchbacks are located at the least one extremity.

Clause 16: A method of controlling a generated amount of thermal energy by a flexible circuit of an article, wherein the flexible circuit includes a trace including a deformable conductor, wherein the trace is configured to generate a first amount of thermal energy when a voltage is applied to the trace via a power source, the method including causing, via a processor, a power source to apply the voltage to the flexible circuit, receiving, via the processor, a first signal from the flexible circuit corresponding to the first amount of thermal energy, determining, via the processor, that the first amount of thermal energy is below a predetermined threshold based on the first signal, generating a second amount of thermal energy when the voltage is applied to the trace in response to a motion of the article, receiving, via the processor, a second signal from the flexible circuit corresponding to the second amount of thermal energy, determining, via the processor, that the second amount of thermal energy exceeds the predetermined threshold based on the second signal, and causing, via the processor, the power source to lower the voltage and/or current applied to the trace based on the determination that the second amount of thermal energy exceeds the predetermined threshold.

Clause 17: The method according to Clause 16, wherein the flexible circuit is configured as a strain sensor, and wherein at least one of the first signal or the second signal includes strain data corresponding to a physical change in the trace.

Clause 18: The method according to either of Clauses 16 or 17, wherein the processor is either mechanically coupled to the article or remotely located relative to the article.

Clause 19: The method according to any of Clauses 16-18, wherein the article further includes a transmitter mechanically coupled to the article and electrically coupled to the flexible circuit, and wherein the transmitter is configured to transmit at least one of the first signal or the second signal to the processor.

Clause 20: The method according to any of Clauses 16-19, wherein at least a portion of the flexible circuit is configured to be locked out, and wherein the first amount of thermal energy and the second amount of thermal energy are generated at portions of the flexible circuit that are not locked out.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc. ” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges in a range of (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein.

Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.).

Accordingly, the non-transitory computer-readable medium includes any type of tangible machine-readable medium suitable for storing or transmitting electronic instructions or information in a form readable by a machine (e.g., a computer).

As used in any aspect herein, any reference to a processor or microprocessor can be substituted for any “control circuit,” which may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

What is claimed is:

1. An article, comprising:
a power source; and
a flexible circuit electrically coupled to the power source, wherein the flexible circuit comprises a trace comprising a deformable conductor configured to generate a predetermined amount of thermal energy when a voltage from the power source is applied to the trace.

2. The article of claim 1, wherein the trace is a first trace, wherein the predetermined amount of thermal energy is a first predetermined amount of thermal energy, and wherein the flexible circuit further comprises at least one second trace comprising the deformable conductor, wherein at least a portion of the at least one second trace defines a region of the flexible circuit, and wherein the region is configured to generate a second predetermined amount of thermal energy when the voltage from the power source is applied to the at least one second trace.

3. The article of claim 1, further comprising:
a processor communicably coupled to the power source and the flexible circuit; and
a memory configured to store instructions that, when executed by the processor, cause the processor to:
receive a signal from the flexible circuit corresponding to a characteristic of the flexible circuit;
determine that the characteristic of the flexible circuit is below a predetermined threshold based on the received signal; and
cause the power source to increase the voltage and/or a current applied to the trace based on the determination that the characteristic is below the predetermined threshold.

4. The article of claim 1, further comprising:
a processor communicably coupled to the power source and the flexible circuit; and
a memory configured to store instructions that, when executed by the processor, cause the processor to:
receive a signal from the flexible circuit corresponding to a characteristic of the flexible circuit;
determine that the characteristic of the flexible circuit exceeds a predetermined threshold based on the received signal; and
cause the power source to lower the voltage and/or a current applied to the trace based on the determination that the characteristic exceeds the predetermined threshold.

5. The article of claim 4, wherein the flexible circuit is configured as a strain sensor, and wherein the signal from the flexible circuit comprises strain data corresponding to a physical change in the trace.

6. The article of claim 2, wherein the flexible circuit is configured for selective control of current flowing through the first trace and the at least one second trace.

7. The article of claim 1, wherein the trace comprises switchbacks, wherein the article has at least one extremity, and wherein the switchbacks are located at the at least one extremity.

8. The article of claim 4, wherein the voltage and/or the current applied to the trace is based on a motion of the article, and wherein the motion is inferred by the processor and the memory from the received signal.

9. A system, comprising:
a power source;
an article comprising a flexible circuit configured to be electrically coupled to the power source, wherein the flexible circuit comprises a trace comprising a deformable conductor, and wherein the trace is configured to generate thermal energy when a voltage from the power source is applied to the trace;
a processor communicably coupled to the power source and the flexible circuit; and
a memory configured to store instructions that, when executed by the processor, cause the processor to:
receive a signal from the flexible circuit corresponding to a characteristic of the flexible circuit;
determine that the characteristic exceeds a predetermined threshold based on the received signal; and
cause the power source to lower the voltage and/or a current applied to the trace based on the determination that the characteristic exceeds the predetermined threshold.

10. The system of claim 9, wherein the trace is a first trace, wherein the characteristic is a first amount of thermal energy generated by the first trace, and wherein the flexible circuit further comprises at least one second trace comprising the deformable conductor, wherein at least a portion of the at least one second trace defines a region of the flexible circuit, and wherein the region is configured to generate a second amount of thermal energy when the voltage from the power source is applied to the at least one second trace.

11. The system of claim 9, wherein the article is configured to lower the voltage and/or the current applied to the trace based on a motion of the article.

12. The system of claim 10, wherein the signal is a first signal, the characteristic includes the second amount of thermal energy, and when executed by the processor the instructions further cause the processor to:
receive a second signal from the flexible circuit;
determine that the second amount of thermal energy exceeds a predetermined threshold based on the second signal; and
cause the power source to lower the voltage and/or the current applied to the at least one second trace based on the determination that the second amount of thermal energy exceeds the predetermined threshold.

13. The system of claim 9, wherein the flexible circuit is configured as a strain sensor, and wherein the signal comprises strain data corresponding a physical change in the trace.

14. The system of claim 9, wherein the flexible circuit is configured for selective control of current flowing through the trace.

15. The system of claim 12, wherein the at least one second trace is configured to have a plurality of switchbacks, wherein the article has at least one extremity, and wherein the plurality of switchbacks are located at the least one extremity.

16. A method of controlling a generated amount of thermal energy by a flexible circuit of an article, wherein the flexible circuit comprises a trace comprising a deformable conductor, wherein the trace is configured to generate a first amount of thermal energy when a voltage is applied to the trace via a power source, the method comprising:
causing, via a processor, a power source to apply the voltage to the flexible circuit;
receiving, via the processor, a first signal from the flexible circuit corresponding to the first amount of thermal energy;
determining, via the processor, that the first amount of thermal energy is below a predetermined threshold based on the first signal;
generating a second amount of thermal energy when the voltage is applied to the trace in response to a motion of the article;
receiving, via the processor, a second signal from the flexible circuit corresponding to the second amount of thermal energy;
determining, via the processor, that the second amount of thermal energy exceeds the predetermined threshold based on the second signal; and
causing, via the processor, the power source to lower the voltage and/or current applied to the trace based on the determination that the second amount of thermal energy exceeds the predetermined threshold.

17. The method of claim 16, wherein the flexible circuit is configured as a strain sensor, and wherein at least one of the first signal or the second signal comprises strain data corresponding to a physical change in the trace.

18. The method of claim 16, wherein the processor is either mechanically coupled to the article or remotely located relative to the article.

19. The method of claim 16, wherein the article further comprises a transmitter mechanically coupled to the article and electrically coupled to the flexible circuit, and wherein the transmitter is configured to transmit at least one of the first signal or the second signal to the processor.

20. The method of claim 16, wherein at least a portion of the flexible circuit is configured to be locked out, and wherein the first amount of thermal energy and the second amount of thermal energy are generated at portions of the flexible circuit that are not locked out.
